(19) United States
(12) Patent Application Publication
(10) Pub. No.: US 2024/0394314 A1
(43) Pub. Date: Nov. 28, 2024

(54) ADDITIVE ONLINE COMPLETE LINKAGE CLUSTERING

(71) Applicant: JAMF Software, LLC, Minneapolis, MN (US)

(72) Inventors: Pavel Danichev, Petah-Tikva (IL); Nir Dov Sidi, Beit Arye (IL); Nir Avraham, Yavne (IL)

(21) Appl. No.: 18/672,945

(22) Filed: May 23, 2024

Related U.S. Application Data
(60) Provisional application No. 63/503,866, filed on May 23, 2023.

(51) Int. Cl. G06F 16/906

(52) U.S. Cl. CPC G06F 16/906

(57) ABSTRACT

In certain aspects, a computer-implemented method includes receiving an incoming element; determining whether a distance of the incoming element to the nearest existing element that is found is above a clustering threshold; creating, based on determining the distance is above the clustering threshold, a new cluster and associating the new cluster to the incoming element; determining, based on determining the distance is not above the clustering threshold, whether distances from the incoming element to contents of the nearest existing element that is found are all below the clustering threshold; associating, based on determining the distances from the incoming element to the contents of the nearest existing element that is found are all below the clustering threshold, associating the incoming element to the cluster of the nearest existing element that is found; processing, based on determining the distances from the incoming element to the contents of the nearest existing element that is found are not all below the clustering threshold, elements of the cluster of the nearest existing element that is found together with the incoming element using an original complete-linkage algorithm, wherein the processing generates a first cluster and a second cluster, wherein the first cluster is smaller than the second cluster; creating another cluster and re-associating elements of the first cluster into the another cluster.

### CROSS-REFERENCE TO RELATED APPLICATION

The present application claims the benefit of priority under 35 U.S.C. § 119 from U.S. Provisional Patent Application Ser. No. 63/503,866 entitled “Additive Online Complete Linkage Clustering,” filed on May 23, 2023, the disclosure of which is hereby incorporated by reference in its entirety for all purposes.

### TECHNICAL FIELD

The present disclosure generally relates to hierarchical clustering, and more specifically relates to additive online complete linkage clustering.

### BACKGROUND

Agglomerative hierarchical clustering methods, such as complete-linkage clustering, are commonly utilized in data mining and statistics for cluster analysis. Such cluster analysis methods generally build a hierarchy of clusters. The original method of complete-linkage clustering is limited to working only in an offline mode because of the complex and time intensive methodology involved to process the full set of collected elements at once. While some traditional agglomerative hierarchical clustering methods approximate the complete-linkage clustering method, a desire exists for a complete-linkage clustering method with improved time efficiency that can process elements sequentially as they are entered into a system.

The description provided in the background section should not be assumed to be prior art merely because it is mentioned in or associated with the background section. The background section may include information that describes one or more aspects of the subject technology.

### SUMMARY

According to certain aspects of the present disclosure, a computer-implemented method is provided. The method includes receiving an incoming element. The method includes determining whether a distance of the incoming element to the nearest existing element that is found is above a clustering threshold. The method includes creating, based on determining the distance is above the clustering threshold, a new cluster and associating the new cluster to the incoming element. The method includes determining, based on determining the distance is not above the clustering threshold, whether distances from the incoming element to contents of the nearest existing element that is found are all below the clustering threshold. The method includes associating, based on determining the distances from the incoming element to the contents of the nearest existing element that is found are all below the clustering threshold, associating the incoming element to the cluster of the nearest existing element that is found. The method includes processing, based on determining the distances from the incoming element to the contents of the nearest existing element that is found are not all below the clustering threshold, elements of the cluster of the nearest existing element that is found together with the incoming element using an original complete-linkage algorithm, wherein the processing generates a first cluster and a second cluster, wherein the first cluster is smaller than the second cluster. The method includes creating another cluster and re-associating elements of the first cluster into the another cluster.

According to other aspects of the present disclosure, a system is provided. The system includes a memory comprising instructions and a processor configured to execute the instructions which, when executed, cause the processor to receive an incoming element. The processor is configured to execute the instructions which, when executed, cause the processor to search for a nearest existing element with respect to the incoming element. The processor is configured to execute the instructions which, when executed, cause the processor to determine whether a distance of the incoming element to the nearest existing element that is found is above a clustering threshold. The processor is configured to execute the instructions which, when executed, cause the processor to create, based on determining the distance is above the clustering threshold, a new cluster and associating the new cluster to the incoming element. The processor is configured to execute the instructions which, when executed, cause the processor to determine, based on determining the distance is not above the clustering threshold, whether distances from the incoming element to contents of the nearest existing element that is found are all below the clustering threshold. The processor is configured to execute the instructions which, when executed, cause the processor to associate, based on determining the distances from the incoming element to the contents of the nearest existing element that is found are all below the clustering threshold, associating the incoming element to the cluster of the nearest existing element that is found. The processor is configured to execute the instructions which, when executed, cause the processor to process, based on determining the distances from the incoming element to the contents of the nearest existing element that is found are not all below the clustering threshold, elements of the cluster of the nearest existing element that is found together with the incoming element using an original complete-linkage algorithm, wherein the processing generates a first cluster and a second cluster, wherein the first cluster is smaller than the second cluster. The processor is configured to execute the instructions which, when executed, cause the processor to create another cluster. The processor is configured to execute the instructions which, when executed, cause the processor to re-associate elements of the first cluster into the another cluster.

According to other aspects of the present disclosure, a non-transitory machine-readable storage medium comprising machine-readable instructions for causing a processor to execute a method is provided. The method includes receiving an incoming element. The method includes determining whether a distance of the incoming element to the nearest existing element that is found is above a clustering threshold. The method includes creating, based on determining the distance is above the clustering threshold, a new cluster and associating the new cluster to the incoming element. The method includes determining, based on determining the distance is not above the clustering threshold, whether distances from the incoming element to contents of the nearest existing element that is found are all below the clustering threshold. The method includes associating, based on determining the distances from the incoming element to the contents of the nearest existing element that is found are all below the clustering threshold, associating the incoming element to the cluster of the nearest existing element that is found. The method includes processing, based on determining the distances from the incoming element to the contents of the nearest existing element that is found are not all below the clustering threshold, elements of the cluster of the nearest existing element that is found together with the incoming element using an original complete-linkage algorithm, wherein the processing generates a first cluster and a second cluster, wherein the first cluster is smaller than the second cluster. The method includes creating another cluster and re-associating elements of the first cluster into the another cluster.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for additive online complete linkage clustering.

FIG. 2 is a block diagram illustrating the example at least one computing device, hierarchical clustering service, and database from the architecture of FIG. 1 according to certain aspects of the disclosure.

FIG. 3 is a block diagram illustrating an example architecture of the database of FIG. 2.

FIG. 4 illustrates an example process for additive online complete linkage clustering using the example at least one computing device, hierarchical clustering service, and database of FIG. 2.

FIG. 5 is block diagram illustrating an example computer system with which the manager device, first managed device, second managed device, mobile management service, and push notification service of FIG. 2 can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The disclosed technology provides a solution to conventional complete-linkage clustering methods. For example, the disclosed technology advantageously approximates complete-linkage clustering with improved time efficiency by processing elements sequentially as received by a system. The disclosed technology provides improvements over traditional approaches by returning cluster association information for each incoming element just after being received by the system, minimizing elements re-associations, and improving time efficiency. Accordingly, the disclosed system can be utilized online, which is an improvement over existing methods that are limited to working only in an offline mode.

Throughout the specification and claims, the following terms take the meanings explicitly associated herein, unless the context clearly dictates otherwise. “Element” is an entity to be clustered and is, but not limited to being, represented as a numeric vector. “Distance” returns a non-negative real number representing the distance between two elements. For example, a distance of zero means the elements are identical. As the value of the distance increases, the elements are more distant from each other. “Clustering threshold” is a user-defined non-negative real number. “Cluster” is a set of near elements. “Complete linkage clustering” is a method according to which the distance between all elements in a cluster must be below the clustering threshold and the distance between clusters defined as the maximum of all the distances between their components. At a first stage, in “agglomerative hierarchical clustering”, each element is considered as a cluster, and next, pairs of nearest clusters are merged to larger clusters. The “agglomerative hierarchical clustering” continues as long as the distance between the clusters to be merged is below the clustering threshold.

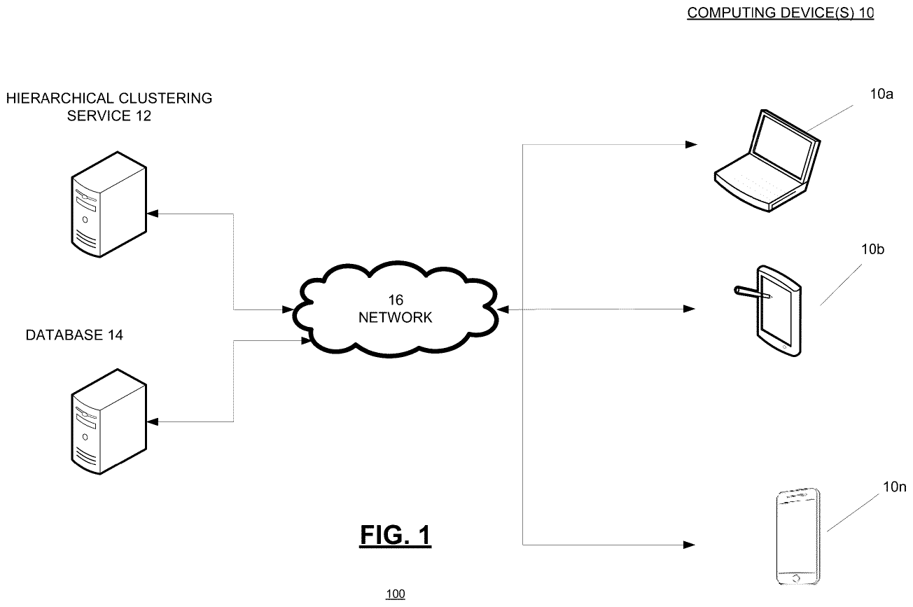

FIG. 1 illustrates an example architecture 100 for additive online complete linkage clustering. For example, the architecture 100 includes at least one computing device 10, such as a first computing device 10a, second computing device 10b to an nth computing device 10n, a hierarchical clustering service 12, and a database 14 all connected over a network 16.

The hierarchical clustering service 12 can be any device having an appropriate processor, memory, and communications capability for communicating with at least one computing device 10 and the database 14. For purposes of load balancing, the hierarchical clustering service 12 may include multiple servers. The at least one computing device 10, such as the first computing device 10a and the second computing device 10b, to which the hierarchical clustering service 12 communicates with over the network 16, can be, for example, a tablet computer, a mobile phone, a mobile computer, a laptop computer, a portable media player, an electronic book (eBook) reader, or any other device having appropriate processor, memory, and communications capabilities. The database 14 can be any device having an appropriate processor, memory, and communications capability for communicating with the hierarchical clustering service 12 and the at least one computing device 10. In certain aspects, the hierarchical clustering service 12 can be a cloud computing server of an infrastructure-as-a-service (IaaS) and be able to support a platform-as-a-service (PaaS) and software-as-a-service (SaaS) services.

The network 16 can include, for example, any one or more of a personal area network (PAN), a local area network (LAN), a campus area network (CAN), a metropolitan area network (MAN), a wide area network (WAN), a broadband network (BBN), the Internet, and the like. Further, the network 16 can include, but is not limited to, any one or more of the following network topologies, including a bus network, a star network, a ring network, a mesh network, a star-bus network, tree or hierarchical network, and the like.

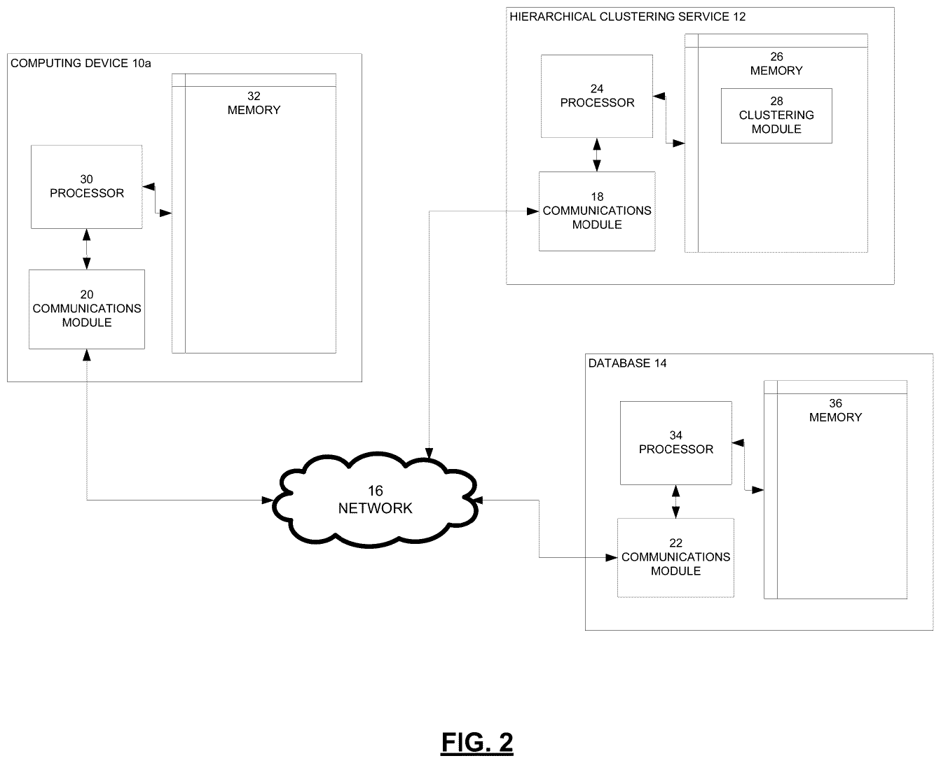

FIG. 2 is a block diagram illustrating examples of the hierarchical clustering service 12, a first computing device 10a of the at least one computing device 10, and the database 14 in the architecture of FIG. 1 according to certain aspects of the disclosure.

The hierarchical clustering service 12, the first computing device 10a of the at least one computing device 10, and the database 14 are connected over the network 16 via respective communication modules 18, 20, 22. The communication modules 18, 20, 22 are configured to interface with the network 16 to send and receive information, such as data, requests, responses, and commands to devices on the network 16. The communications modules 18, 20, 22 can be, for example, modems or Ethernet cards.

The hierarchical clustering service 12 includes a processor 24, the communications module 18, and a memory 26 that includes a clustering module 28. The processor 24 of the hierarchical clustering service 12 is configured to execute instructions, such as instructions physically coded into the processor 24, instructions received from software in the memory 26, or a combination of both. The processor 24 of the hierarchical clustering service 12 is configured to receive a clustering threshold from, but not limited to, the first computing device 10a of the at least one computing device 10. For each incoming element, the processor 24 of the hierarchical clustering service 12, via the clustering module 28, is configured to linearly search for the nearest existing element. If no such element is found within the clustering threshold, the processor 24 of the hierarchical clustering service 12, via the clustering module 28, is configured to create a new cluster associated to the incoming element.

On the other hand, if an element is found within the clustering threshold, the processor 24 of the hierarchical clustering service 12, via the clustering module 28, is configured to add the incoming element to an existing cluster (e.g., a target cluster) associated with the nearest existing element based on complying with a complete linkage constraint. For example, the complete linkage constraint is that all distances between all elements in a cluster must be below the clustering threshold.

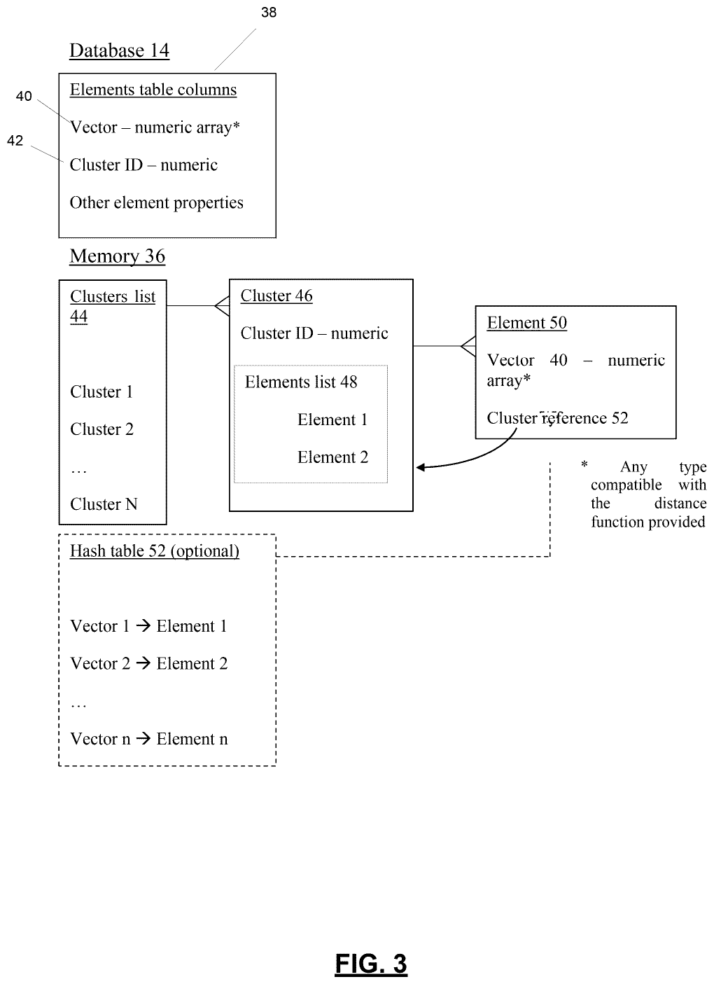

If the complete linkage constraint is violated, however, the hierarchical clustering service 12, via the clustering module 28, is configured to run a complete-linkage algorithm on the elements of the target cluster together with the incoming element resulting in splitting of the target cluster into two valid clusters with the incoming element in one of the two valid clusters. For example, and with reference to FIG. 3, the database 14 includes an elements table 38, which can be organized to include columns associated with element properties such as, but not limited to, vector 40, cluster ID 42, and other appropriate element properties. The memory 36 is configured to store a cluster list 44 of at least one cluster 46. Each cluster 46 includes a cluster ID 42, which contains an element list 48 of at least one element 50. Each element 50 contains a vector 40 and a cluster reference 52, which is a reference to its parent cluster.

In certain aspects, as an optimization, when the data is appropriate (e.g., vectors of discrete values), a hash table 54 can be utilized in searching for identical existing elements prior to the linear search. In such aspects, when an identical element is found, the incoming element is immediately associated to the cluster of the identical existing element. It is enough to store only unique elements under each cluster in the data structure used for the linear (and hashed) search.

As described above, the hierarchical clustering service 12, via the clustering module 28, is configured to perform advantages in terms of implementation and memory consumption while also allowing for distributed processing such that it is horizontally scalable. Accordingly, different clusters with their components can reside on different machines. For each incoming element, the nearest element on each machine can be searched concurrently, then the results can be reduced to the nearest-of-nearest. Adding the element and splitting the cluster, if required, continues on the machine where the absolute nearest was found. In certain aspects, hierarchical clustering service 12, via the clustering module 28, is configured to perform with stack traces data of software crash reports with a measured time complexity that is quadratic. In certain aspects where cluster associations are stored in a database, the hierarchical clustering service 12, via the clustering module 28, provides economical benefits since the number of updates for already clustered data is reduced as compared to conventional approaches. In systems that include initial data, the initial data can be clustered once using the original complete-linkage approach, an then the hierarchical clustering service 12, via the clustering module 28, can use the results as an initial state to increase accuracy for the next incoming data.

The first computing device 10a includes a processor 30, the communications module 20, and a memory 32. The processor 30 of the first computing device 10a is configured to execute instructions, such as instructions physically coded into the processor 30, instructions received from software in memory 32, or a combination of both. The processor 30 of the first computing device 10a is configured to transmit the clustering threshold to the hierarchical clustering service 12.

The database 14 includes a processor 34, the communications module 22, and a memory 36. The processor 34 of the push notification service 16 is configured to execute instructions, such as instructions physically coded into the processor 36, instructions received from software in the memory 38, or a combination of both.

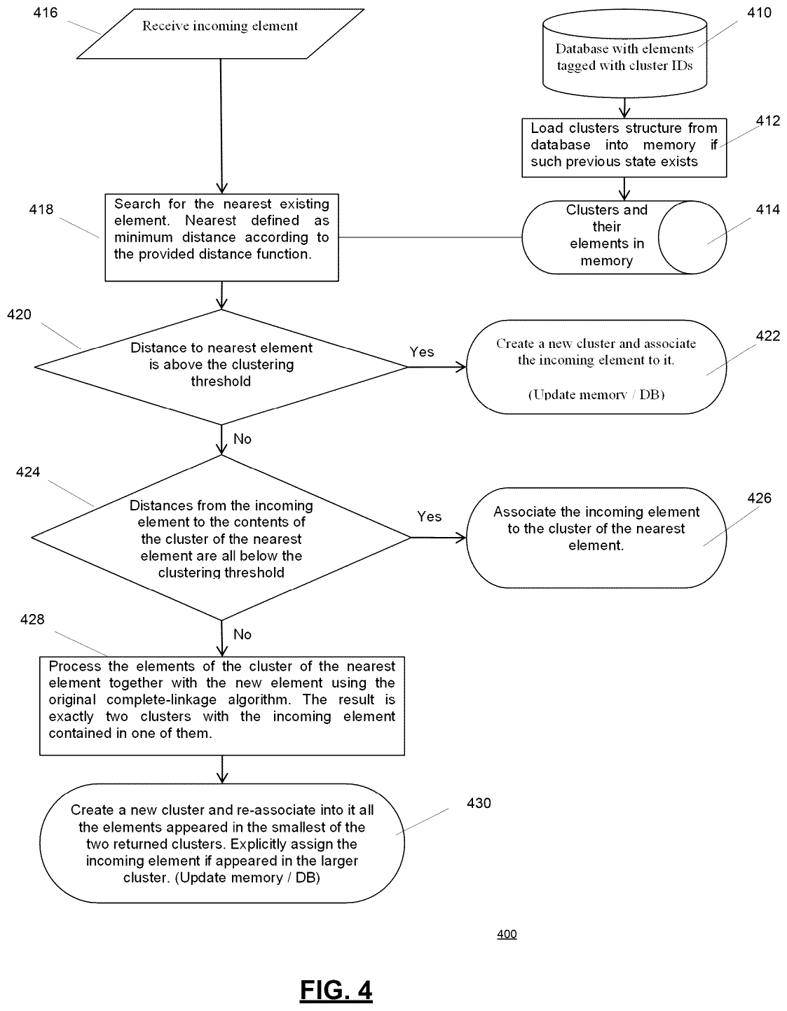

FIG. 4 illustrates an example process 400 for additive online complete linkage clustering using the hierarchical clustering service 12, the first computing device 10a of the at least one computing device 10, and the database 14 of FIG. 2. While FIG. 4 is described with reference to FIG. 2, it should be understood that the process steps of FIG. 4 may be performed by other systems.

As depicted at block 410, the database 14 includes elements 50 tagged with cluster IDs 42. Cluster structures of the clusters 46 are loaded from the database 14 into the memory 36, if such previous state exists, as illustrated at block 410. The clusters 46 and their associated elements 50 are stored in the memory 36, as depicted at block 414.

The process 400 starts at block 416 with the processor 24 of the hierarchical clustering service 12 receiving an incoming element 50. Responsive to receiving the incoming element 50, the processor 24 of the hierarchical clustering service 12 searches for the nearest existing element stored in the memory 36, as illustrated at block 418. The nearest existing element is defined as a minimum distance according to the provided distance function.

At block 420, the processor 24 of the hierarchical clustering service 12 determines whether the distance of the incoming element to the nearest found element is above the clustering threshold. If the distance of the incoming element to the nearest element is above the clustering threshold, the processor 24 of the hierarchical clustering service 12 creates a new cluster, associates the new cluster to the incoming element, and updates the memory 36 of the database 14, as depicted a block 422. On the other hand, if the distance of the incoming element to the nearest element is not above the clustering threshold, the processor 24 of the hierarchical clustering service 12 then determines, as depicted at block 424, whether distances from the incoming element to the contents of the nearest found element are all below the clustering threshold. If the distances from the incoming element to the contents of the nearest found element are all below the clustering threshold, the processor 24 of the hierarchical clustering service 12 associates the incoming element 50 to the cluster of the nearest element, as depicted at block 426. If the distances from the incoming element to the contents of the nearest found element are not all below the clustering threshold, the processor 24 of the hierarchical clustering service 12 processes the elements of the cluster of the nearest element together with the incoming element using the original complete-linkage algorithm, as depicted at block 428. As a result, the processor 24 of the hierarchical clustering service 12 generates two clusters (e.g., a first cluster and a second cluster) with the incoming element contained in one of the two clusters. Responsive to generating the two clusters, the processor 24 of the hierarchical clustering service 12 creates a new cluster and re-associates all the elements that appeared in the smallest of the two returned clusters into the new cluster, as depicted at block 430. If the incoming element appeared in the larger of the two returned clusters, the processor 24 of the hierarchical clustering service 12 explicitly assigns the incoming element and updates the memory 36 of the database 14.

With reference to FIGS. 1-4, an exemplary process according to certain aspects is described in detail below. For each incoming element received at the processor 24 of the hierarchical clustering service 12, the clustering module 28 checks if the element's vector 40 is already contained in the hash map (e.g., the hash table 52) and ends. If the element's vector 40 is contained in the hash map, the clustering module 28 sets a cluster ID 42 of the incoming element to the cluster ID 42 of the parent cluster of the element object found in the hash map. If the element's vector 40 is not contained in the hash map, the clustering module 28 creates a new element object for this incoming element and adds this new element object to the hash map. (This can be performed in a single operation with the check operation.) The element object doesn't have a reference to a cluster at this point. The clustering module 28 then goes over all existing clusters in the memory 36. For each cluster, the clustering module 28 goes over all the elements of the cluster and (1) measures the distance between the vector of the incoming element and the vectors of the clustered elements using the provided distance function, (2) if the distance is below that of the nearest element, updates it to reference the tested element and update the nearest distance, and (3) updates the max distance from incoming element to cluster's elements if the current distance is above the previous value. If the nearest element was updated during the iterations on this cluster and max distance from the incoming element to cluster's elements is greater than the clustering threshold, the clustering module 28 sets the value of requires rebuild (is the cluster of the nearest element contains any element with distance from the incoming element higher than the clustering threshold) to true (otherwise it stays false).

If the nearest distance is greater than the clustering threshold, the clustering module 28 (1) creates a new cluster object with new cluster ID, adds the element object to that cluster and adds the reverse reference from the object to the cluster, (2) adds the new cluster to the clusters list 44, (3) sets the cluster ID 42 of the incoming element to that of the new cluster and ends.

If require rebuild is false (the new element doesn't cause any other element in the cluster to become further than threshold), the clustering module 28 (1) adds the new element object to the parent cluster of nearest element and add reverse reference to that cluster to the element object, (2) sets the cluster ID 42 of the incoming element to that of the parent of the nearest element and ends.

The clustering module 28 takes all the elements from the parent cluster of the nearest element and adds the new element object to them. The clustering module 28 feeds this list to the original complete-linkage clustering algorithm, which returns two clusters (e.g., the first cluster and the second cluster). With the two clusters created, the clustering module 28 (1) replaces the contents of the parent cluster of nearest element with the contents of the largest of the returned clusters. Set reference to that cluster in the contained element objects, (2) creates a new cluster object with new cluster ID and adds it to the list of clusters (fill this cluster with the contents of the smaller returned cluster after converting them to cluster objects with the bi-directional references between cluster and contained elements), (3) updates the cluster ID of all the elements of the new cluster and explicitly updates the incoming element, if that was assigned to the existing cluster (other elements of the existing cluster don't require update because they keep the old cluster ID) and ends.

With reference to FIGS. 1-4, an exemplary process according to certain aspects in which the complete-linkage clustering algorithm is utilized is described in detail below. For each input vector, the complete-linkage clustering algorithm creates a cluster object that holds this single vector wrapped as an element. In case the discrete vectors optimization is relevant, in the process of this collection use hash map where the vectors are keys, in order to ignore duplications. This list of clusters would be the first/bottom level of the clustering hierarchy. The complete-linkage clustering algorithm merges clusters of one level as long as the output of the previous level is not empty, where the input for this part is an (ordered) list of clusters of size Ne, (1) prepares two arrays with length equal to Ne: nearest IDs and nearest IDs distances, (2) initializes nearest IDs distances with infinity values, and (3) for each index i from 0 to N_{c} (exclusive): for each index j from i+1 to N_{c} (exclusive): (a) measures the distance between cluster at index i and cluster at index j (Distance between clusters defined as the maximum of the distances between all their components. The distance between each two components (vectors) is calculated using the provided distance function), (b) if the distance is less than the value in index i of nearest IDs distances, updates the value at i with the new distance and set the value j in index i of nearest IDs. (Note that in the beginning of this inner loop, index i of the arrays already contains the optimal values for i as measured for j<i from previous iterations of the outer loop that runs on the i index.)

Following this, for each cluster i has a reference (index) of its nearest cluster and the distance between them.

For each index i from 0 to N_{c} (exclusive), the complete-linkage clustering algorithm (1) if the list of clusters is empty at index i, continues to next i (explanation below), (2) if the nearest distance as appears in index i of nearest IDs distances is above the clustering threshold, adds cluster i to the list of final clusters and continue to next i, (3) (The value at i of nearest IDs (hereafter j) is the index of the nearest cluster to i.) if the value at j of nearest IDs equals i this means they are pointing on each other so they are a “nearest pair,” adds all elements of cluster j into the elements list of cluster i and erase the content of cell j of the clusters list so element j won't be processed in following iterations, and (4) adds cluster i to the list of next level clusters.

If this list of next level clusters is not empty, the complete-linkage clustering algorithm repeats merging clusters with the list of next level clusters. For each cluster in the list of final clusters, for each element in the cluster, the complete-linkage clustering algorithm sets reference to its parent cluster. The list of final clusters is the complete-linkage clustering algorithm's output.

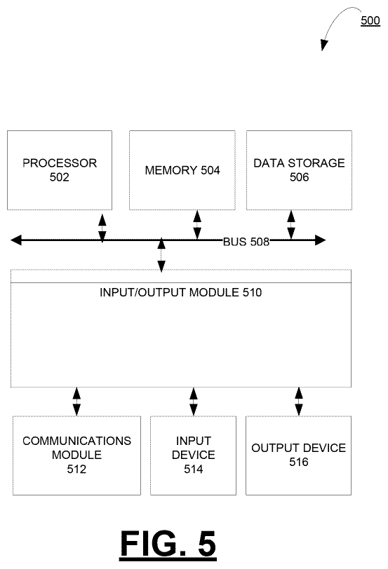

FIG. 5 is a block diagram illustrating an example computer system 500 with which the at least one computing device 10, such as the first computing device 10a, the hierarchical clustering service 12, and the database 14 of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., the at least one computing device 10, such as the first computing device 10a, the hierarchical clustering service 12, and the database 14) includes a bus 508 or other communication mechanism for communicating information, and a processor 502 (e.g., the processor 24, 30, 34) coupled with bus 508 for processing information. According to one aspect, the computer system 500 can be a cloud computing server of an IaaS that is able to support PaaS and SaaS services.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., the memory 26, 32, 36), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, e.g., one or more modules of computer program instructions encoded on a computer readable medium for execution by, or to control the operation of, the computer system 500.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Example input/output modules 510 include data ports such as USB ports. In addition, input/output module 510 may be provided in communication with processor 502, so as to enable near area communication of computer system 500 with other devices. The input/output module 510 may provide, for example, for wired communication in some implementations, or for wireless communication in other implementations, and multiple interfaces may also be used. The input/output module 510 is configured to connect to a communications module 512. Example communications modules 512 (e.g., the communications module 18, 20, 22) include networking interface cards, such as Ethernet cards and modems.

In certain aspects, the input/output module 510 is configured to connect to a plurality of devices, such as an input device 514 and/or an output device 516. Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device.

According to one aspect of the present disclosure the at least one computing device 10, such as the first computing device 10a, the hierarchical clustering service 12, and the database 14 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. Processor 502 may process the executable instructions and/or data structures by remotely accessing the computer program product, for example by downloading the executable instructions and/or data structures from a remote server through communications module 512 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

The term “machine-readable storage medium” or “computer-readable medium” as used herein refers to any medium or media that participates in providing instructions or data to processor 502 for execution. The term “storage medium” as used herein refers to any non-transitory media that store data and/or instructions that cause a machine to operate in a specific fashion. Such a medium may take many forms, including, but not limited to, non-volatile media, volatile media, and transmission media.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 508. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in either one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method comprising:
receiving an incoming element;
searching for a nearest existing element with respect to the incoming element;
determining whether a distance of the incoming element to the nearest existing element that is found is above a clustering threshold;
creating, based on determining the distance is above the clustering threshold, a new cluster and associating the new cluster to the incoming element;
determining, based on determining the distance is not above the clustering threshold, whether distances from the incoming element to contents of the nearest existing element that is found are all below the clustering threshold;
associating, based on determining the distances from the incoming element to the contents of the nearest existing element that is found are all below the clustering threshold, associating the incoming element to the cluster of the nearest existing element that is found;
processing, based on determining the distances from the incoming element to the contents of the nearest existing element that is found are not all below the clustering threshold, elements of the cluster of the nearest existing element that is found together with the incoming element using an original complete-linkage algorithm, wherein the processing generates a first cluster and a second cluster, wherein the first cluster is smaller than the second cluster;
creating another cluster; and
re-associating elements of the first cluster into the another cluster.

2. The computer-implemented method of claim 1, further comprising:
assigning, based on the incoming element being in the second cluster, the incoming element.

3. The computer-implemented method of claim 1, wherein the searching for the nearest existing element with respect to the incoming element further comprises:
searching in a database, wherein the database comprises elements tagged with cluster IDs.

4. The computer-implemented method of claim 1, wherein the searching for the nearest existing element with respect to the incoming element further comprises:
determining whether a vector of the incoming element is contained in a hash table.

5. The computer-implemented method of claim 4, further comprising:
setting, based on determining the vector of the incoming element is contained in the hash table, a cluster ID of the incoming element to a cluster ID of a parent cluster of an element object found in the hash map.

6. The computer-implemented method claim 5, further comprising:
creating, based on determining the vector of the incoming element is not contained in the hash table, a new element object associated with the incoming element.

7. The computer-implemented method of claim 6, further comprising:
adding the new element object to the hash table.

8. A system comprising:
a memory comprising instructions; and
a processor configured to execute the instructions which, when executed, cause the processor to:
receive an incoming element;
search for a nearest existing element with respect to the incoming element;
determine whether a distance of the incoming element to the nearest existing element that is found is above a clustering threshold;
create, based on determining the distance is above the clustering threshold, a new cluster and associating the new cluster to the incoming element;
determine, based on determining the distance is not above the clustering threshold, whether distances from the incoming element to contents of the nearest existing element that is found are all below the clustering threshold;
associate, based on determining the distances from the incoming element to the contents of the nearest existing element that is found are all below the clustering threshold, associating the incoming element to the cluster of the nearest existing element that is found;
process, based on determining the distances from the incoming element to the contents of the nearest existing element that is found are not all below the clustering threshold, elements of the cluster of the nearest existing element that is found together with the incoming element using an original complete-linkage algorithm, wherein the processing generates a first cluster and a second cluster, wherein the first cluster is smaller than the second cluster;
create another cluster; and
re-associate elements of the first cluster into the another cluster.

9. The system of claim 8, further comprising instructions to cause the processor to:
assign, based on the incoming element being in the second cluster, the incoming element.

10. The system of claim 8, wherein the instructions to cause the processor to search for the nearest existing element with respect to the incoming element further comprises:
search in a database, wherein the database comprises elements tagged with cluster IDs.

11. The system of claim 8, wherein the instructions to cause the processor to search for the nearest existing element with respect to the incoming element further comprises:
determine whether a vector of the incoming element is contained in a hash table.

12. The system of claim 11, further comprising instructions to cause the processor to:
set, based on determining the vector of the incoming element is contained in the hash table, a cluster ID of the incoming element to a cluster ID of a parent cluster of an element object found in the hash map.

13. The system of claim 12, further comprising instructions to cause the processor to:
create, based on determining the vector of the incoming element is not contained in the hash table, a new element object associated with the incoming element.

14. The system of claim 13, further comprising instructions to cause the processor to:
add the new element object to the hash table.

15. A non-transitory machine-readable storage medium comprising machine-readable instructions for causing a processor to execute a method, the method comprising:
receiving an incoming element;
searching for a nearest existing element with respect to the incoming element;
determining whether a distance of the incoming element to the nearest existing element that is found is above a clustering threshold;
creating, based on determining the distance is above the clustering threshold, a new cluster and associating the new cluster to the incoming element;
determining, based on determining the distance is not above the clustering threshold, whether distances from the incoming element to contents of the nearest existing element that is found are all below the clustering threshold;
associating, based on determining the distances from the incoming element to the contents of the nearest existing element that is found are all below the clustering threshold, associating the incoming element to the cluster of the nearest existing element that is found;
processing, based on determining the distances from the incoming element to the contents of the nearest existing element that is found are not all below the clustering threshold, elements of the cluster of the nearest existing element that is found together with the incoming element using an original complete-linkage algorithm, wherein the processing generates a first cluster and a second cluster, wherein the first cluster is smaller than the second cluster;
creating another cluster; and
re-associating elements of the first cluster into the another cluster.

16. The non-transitory machine-readable storage medium of claim 15, further including instructions for causing the processor to execute the method comprising:
assigning, based on the incoming element being in the second cluster, the incoming element.

17. The non-transitory machine-readable storage medium of claim 15, wherein the instructions for causing the processor to execute searching for the nearest existing element with respect to the incoming element further comprises:
searching in a database, wherein the database comprises elements tagged with cluster IDs.

18. The non-transitory machine-readable storage medium of claim 15, wherein the instructions for causing the processor to execute searching for the nearest existing element with respect to the incoming element further comprises:
determining whether a vector of the incoming element is contained in a hash table.

19. The non-transitory machine-readable storage medium of claim 18, further including instructions for causing the processor to execute the method comprising:
setting, based on determining the vector of the incoming element is contained in the hash table, a cluster ID of the incoming element to a cluster ID of a parent cluster of an element object found in the hash map.

20. The non-transitory machine-readable storage medium of claim 19, further including instructions for causing the processor to execute the method comprising:
creating, based on determining the vector of the incoming element is not contained in the hash table, a new element object associated with the incoming element; and
adding the new element object to the hash table.
